(19) United States
(12) Patent Application Publication
(10) Pub. No.: US 2019/0028917 A1
(43) Pub. Date: Jan. 24, 2019

(54) SELECTIVE REJECTION OF CONNECTION REQUEST

(71) Applicant: Sony Mobile Communications Inc., Tokyo (JP)

(72) Inventors: Svante ALNÅS, Lund (SE); Anders BERGGREN, Lund (SE); Bo LARSSON, Lund (SE)

(21) Appl. No.: 16/069,237

(22) PCT Filed: Jan. 11, 2016
(86) PCT No.: PCT/EP2016/050395

§ 371 Date: Jul. 11, 2018

(51) Int. Cl. H04W 28/02; H04W 76/18; H04W 48/06

(52) U.S. Cl. CPC H04W 28/0231; H04W 28/12; H04W 48/06; H04W 76/18

(57) ABSTRACT

In response to a need for communication of uplink data on the radio link of a wireless network between a terminal and a node, participation in a setup procedure for establishing a data connection on the radio link takes place. A first control message indicative of a delay requirement of the uplink data is communicated during the setup procedure. During the setup procedure and in response to said communicating of the first control message, a second control message is selectively communicated which rejects the data connection.

Various embodiments relate to a method and to a corresponding device. In particular, various embodiments relate to techniques of rejecting a data connection during a setup procedure for establishing the data connection.

### BACKGROUND

The number of terminals attached to cellular networks continuously increases. Further, the total amount of data communicated on radio links of cellular networks also increases. Because of this, congestion may occur where a traffic load on the radio links exceed capacity. Where congestion occurs, delay requirements of data communicated on the radio link may be at risk.

According to the Third Generation Partnership Project (3GPP) Technical Specification (TS) 22.011, version 14.1.0 (2015-12), chapter 4.3.1, a terminal is a member of at least one Access Class (AC). Access Class Barring (ACB) can be implemented; here, via a broadcasted configuration control message System Information Block (SIB), the terminals of certain Access Classes can be excluded from participating in setup procedures for establishing a data connection on the radio link.

However, such techniques of ACB face certain restrictions and drawbacks. E.g., such techniques may suffer from limited flexibility. In particular, where a terminal being part of a barred AC wishes to communicate data of high importance, this may not be possible or only possible to a limited degree within existing implementations of ACB.

### SUMMARY

Therefore, a need exists for advanced techniques of implementing a setup procedure for establishing a data connection. In particular, a need exists for techniques of implementing a setup procedure for establishing a data connection which overcome or mitigate at least some of the above-mentioned drawbacks. A need exists for techniques which enable flexible rejection of data connections.

This need is met by the features of the independent claims. The features of the dependent claims define embodiments.

According to an embodiment, a method is provided. The method comprises, in response to a need for communication of uplink data on a radio link of a cellular network: participating in a setup procedure for establishing a data connection on the radio link. The radio link is between a terminal and a node of the cellular network. The method further comprises, during the setup procedure: communicating, from the terminal to the node, a first control message. The first control message is indicative of a delay requirement of the uplink data. The method further comprises, during the setup procedure: selectively communicating, from the node to the terminal, a second control message. The second control message rejects the data connection.

According to an embodiment, a device is provided. The device comprises an interface. The interface is configured to communicate on a radio link. The radio link is between a terminal and a node of a cellular network. The device further comprises at least one processor. The at least one processor is configured to participate in a setup procedure for establishing a data connection on the radio link. Said participating is in response to a need for communication of uplink data. The at least one processor is further configured to communicate, during the setup procedure and via the interface, a first control message. The first control message is indicative of a delay requirement of the uplink data. The at least one processor is further configured to selectively communicate, during the setup procedure and via the interface, a second control message. The second control message rejects the data connection.

The device may be configured to execute the method according to further embodiments. For such a device, effects may be obtained which are comparable to the effects that may be obtained with a method according to further embodiments.

According to an embodiment, a computer program product is provided. The computer program product comprises program code that may be executed by at least one processor. Executing the program code causes the at least one processor to perform a method. The method comprises, in response to a need for communication of uplink data on a radio link of a cellular network: participating in a setup procedure for establishing a data connection on the radio link. The radio link is between a terminal and a node of the cellular network. The method further comprises, during the setup procedure: communicating, from the terminal to the node, a first control message. The first control message is indicative of a delay requirement of the uplink data. The method further comprises, during the setup procedure: selectively communicating, from the node to the terminal, a second control message. The second control message rejects the data connection.

According to embodiments, a method is provided. The method comprises, in response to a need for communication of uplink data on a radio link of a cellular network:

participating in a setup procedure for establishing a data connection on the radio link. The radio link is between a terminal and a node of the cellular network. The method further comprises, during the setup procedure: receiving, from the terminal, a first control message. The first control message is indicative of a delay requirement of the uplink data. The method further comprises, during the setup procedure: selectively sending, to the terminal, a second control message. The second control message rejects the data connection.

According to embodiments, a method is provided. The method comprises, in response to a need for communication of uplink data on a radio link of a cellular network:

participating in a setup procedure for establishing a data connection on the radio link. The radio link is between a terminal and a node of the cellular network. The method further comprises, during the setup procedure: sending, to the node, a first control message. The first control message is indicative of a delay requirement of the uplink data. The method further comprises, during the setup procedure: selectively receiving, from the node, a second control message. The second control message rejects the data connection.

According to embodiments, a device is provided. The device comprises means for participating in a setup procedure for establishing a data connection on the radio link in response to a need for communication of uplink data on a radio link of a cellular network. The radio link is between a terminal and a node of the cellular network. The device further comprises means for communicating, from the terminal to the node, a first control message during the setup procedure. The first control message is indicative of a delay requirement of the uplink data. The device further comprises means for selectively communicating, from the node to the terminal, a second control message during the setup procedure. The second control message rejects the data connection.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 is a schematic illustration of a cellular network according to various embodiments.

FIG. 2 is a schematic illustration of a communication protocol stack used for communicating on the radio link of the cellular network according to various embodiments, wherein the communication protocol stack comprises a Medium Access Control layer and a Physical layer.

FIG. 3 is a signaling diagram of a setup procedure for establishing a data connection on the radio link according to reference implementations.

FIG. 4 is a signaling diagram of the setup procedure for establishing the data connection on the radio link according to various embodiments, wherein the data connection in the example of FIG. 4 is rejected for postponing communication of uplink data.

FIG. 5 is a signaling diagram of the setup procedure for establishing the data connection on the radio link according to various embodiments, wherein the data connection in the example of FIG. 5 is rejected for postponing communication of uplink data.

FIG. 6 is a schematic illustration of a first control message communicated during the setup procedure and indicative of a delay requirement of uplink data according to various embodiments, wherein in the scenario of FIG. 6 the control message includes an indicator explicitly indicative of the delay requirement of the uplink data.

FIG. 7 is a schematic illustration of the first control message communicated during the setup procedure and indicative of the delay requirement of the uplink data according to various embodiments, wherein in the scenario of FIG. 7 the control message includes an indicator indicative of a service class of the uplink data, wherein the service class is associated with the delay requirement.

FIG. 8A illustrates a configuration control message according to various embodiments, wherein the configuration control message includes an indicator indicative of a threshold delay, wherein the configuration control message may be communicated on a broadcast channel in shared resources.

FIG. 8B is a schematic illustration of the first control message indicative of the delay requirement of the uplink data according to various embodiments, wherein in the scenario of FIG. 8B the control message includes an indicator indicative of the delay requirement relative to the threshold delay indicated by the configuration control message of FIG. 8A.

FIG. 9 is a schematic illustration of the first control message indicative of the delay requirement of the uplink data according to various embodiments, wherein in the scenario of FIG. 9 the first control message includes a coding preamble indicative of the delay requirement, wherein FIG. 9 further illustrates selecting the coding preamble from a plurality of classes.

FIG. 10 is a schematic illustration of a terminal according to various embodiments.

FIG. 11 is a schematic illustration of an access node of the cellular network according to various embodiments.

FIG. 12 is a flowchart of a method according to various embodiments.

FIG. 13 is a flowchart of a method according to various embodiments.

FIG. 14 is a flowchart of a method according to various embodiments.

### DETAILED DESCRIPTION OF EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter techniques of participating in a setup procedure for establishing a data connection on the radio link are disclosed. In some examples, the data connection is rejected. The rejection of the data connection may depend on various decision criteria, such as a delay requirement of uplink (UL) data to be communicated. These techniques may be employed for load balancing.

In particular, during the setup procedure, a first control message may be indicative of the delay requirement of UL data; then, in response to communicating the first control message, the data connection may be rejected or may be accepted (selectively rejecting). By selectively rejecting the data connection, on the one hand side, congestion on the radio link may be avoided.

In some examples, the data connection may be rejected depending on the delay requirement. E.g., if the delay requirement indicates that communication of the UL data is not very urgent (relaxed delay requirement), then it may be decided to postpone communication of the UL data and the data connection may be rejected. By considering the delay requirement of the UL data when deciding whether to reject or accept the data connection, loss of important data our delivery of outdated data may be avoided.

The delay requirement may describe how urgent successful communication and/or delivery and/or processing of the data by a recipient is. UL data having a relaxed delay requirement may not be required to be communicated on a short time scale and/or processed on a short time scale. E.g., the delay requirement may correlate with a temporal validity of information included in the UL data: E.g., periodic status reports being issued periodically with a certain repetition time may have a delay requirement on the same time scale of the repetition time.

In some examples, it is possible that later on the data connection is later on established using a further setup procedure; then, after a certain time, communication of the initially postponed UL data may be executed. Such techniques relate to postponing communication of the UL data. By postponing communication of the UL data, load balancing may be possible. E.g., communication of the UL data may be postponed until congestion on the radio link has been resolved.

In various examples, alternatively or additionally to considering the delay requirement of the UL data, further decision criteria may be taken into account when deciding to reject the data connection. Examples include: the size of the UL data; a traffic load on the radio link; and a timing policy of communication on the radio link. By considering such alternative for additional decision criteria, it is possible to flexibly adjust the rejection policy. In particular, in-time delivery of important data may be balanced against congestion situations on the radio link

By such techniques, it becomes possible to effectively execute load balancing on the radio link. In particular, congestion may be mitigated. This may be achieved by prioritizing the traffic, e.g., depending on delay requirement of corresponding UL data. E.g., comparably urgent UL data may be prioritized over UL data which is not very urgent by selectively rejecting the data connection for the UL data that is not very urgent. The techniques enable to implement such load balancing in a differentiated and well-informed manner. In particular, if compared to reference implementations which operate based on ACB techniques, specific properties of the UL data for which a need for communication on the radio link exists may be taken into account.

Techniques are disclosed herein with reference to cellular networks. In other examples, communication on radio links non-cellular wireless networks may also be facilitated using the techniques disclosed herein.

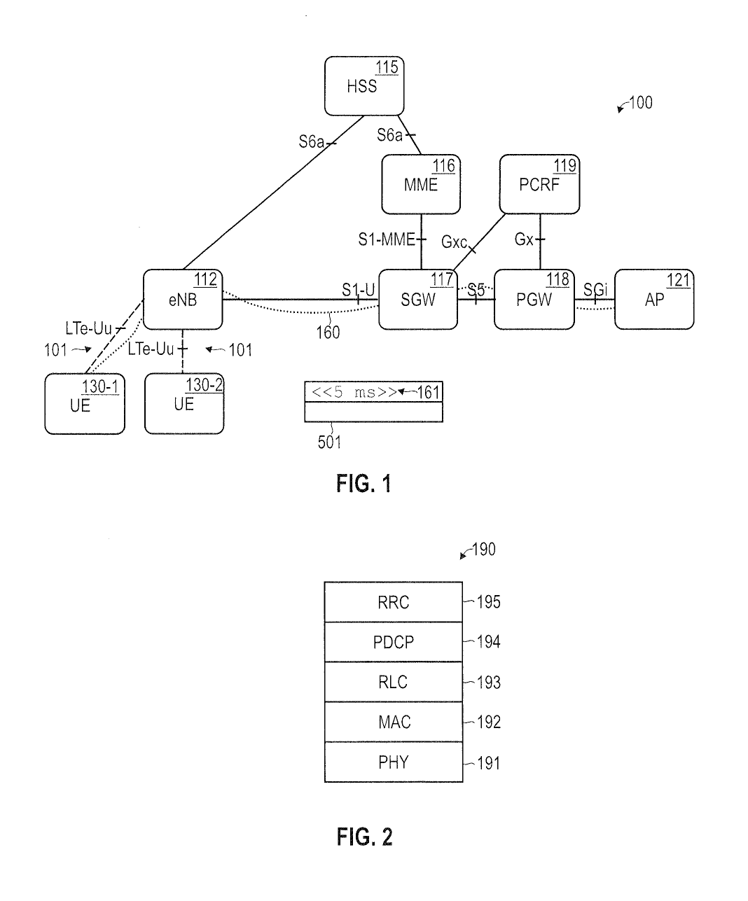

FIG. 1 illustrates the architecture of a cellular network 100 according to some examples implementations. In particular, the cellular network 100 according to the example of FIG. 1 implements the 3GPP Long Term Evolution (LTE) architecture, sometimes referred to as evolved packet system (EPS). This, however, is for exemplary purposes only. In particular, various scenarios will be explained in the context of a radio link 101 between a terminal 130-1 and the cellular network 100 operating according to the 3GPP LTE radio access technology (RAT) for illustrative purposes only. Similar techniques can be readily applied to various kinds of 3GPP-specified RATs, such as

Global Systems for Mobile Communications (GSM), Wideband Code Division Multiplex (WCDMA), General Packet Radio Service (GPRS), Enhanced Data Rates for GSM Evolution (EDGE), Enhanced GPRS (EGPRS), Universal Mobile Telecommunications System (UMTS), and High Speed Packet Access (HSPA), and corresponding architectures of associated cellular networks.

A further particular example is the 3GPP NB-IoT RAT. The 3GPP NB-IoT RAT may be based on the 3GPP LTE RAT, i.e., the Evolved UMTS Terrestrial Radio Access (E-UTRA). Further, the NB-IoT RAT may be combined with the EPS as illustrated in FIG. 1. The various examples disclosed herein may be readily implemented for the 3GPP NB-IoT RAT, alternatively or additionally.

The terminal 130-1 communicates (sends and/or receives) messages via the radio link 101 to and from an access node 112 of the cellular network 100. The access node 112 and the terminal 130 implement the E-UTRA; therefore, the access point node 112 is an eNB 112. In FIG. 1 a scenario is disclosed where a data connection 160 is established on the radio link 101. UL data 501 may be communicated employing the data connection 160.

E.g., the UL data 501 may be packetized payload data of applications implemented by the terminal 130-1 and/or the cellular network 100. As such, the UL data 501 may also be referred to as UL higher-layer payload data 501. In particular, such higher-layer payload data may be distinct from control data which is employed for configuring properties of the radio link 101, the terminal 130-1 and/or nodes of the cellular network 100.

In some examples, the data connection 160 may correspond to a bearer or secure bearer (tunnel) which is used to forward the UL data 501 through the cellular network 100. An EPS bearer which is characterized by a certain set of quality of service parameters may be indicated by the QoS class identifier (QCI) which identifies the service class. In particular, a state where the data connection 160 is established may be referred to as Radio Resource Control (RRC) Connected. A state where the data connection 160 is not established is sometimes referred to as RRC Idle.

The UL data 501 may be associated with a certain delay requirement 161. The delay requirement 161 may specify a time duration available for completing communication of the UL data 501 and/or may specify a time duration during which the data should be made available for processing by a recipient. The delay requirement 161 may specify a requirement which should be met for each piece of data or, at least, on average for an ensemble of data. In some examples, the delay requirement 161 may be associated with the service class into which the UL data 501 is grouped; it is possible that the data connection 160 is associated with this service class and, thus, with the delay requirement 161. Example service classes include: measurement reports; status updates; best-effort traffic; time-critical data; non-time-critical data; emergency data; and/or warnings; etc.

A further terminal 130-2 is also connected to the eNB 112. Because of the plurality of terminals 130-1, 130-2, congestion situations may occur. In a congestion situation and available bandwidth for communication of data on the radio link 101 may not be sufficient for communicating all data for which an need for communication on the radio link 101 exists, i.e., which are scheduled for communication and reside, e.g., in an transmission buffer. Hereinafter, techniques are disclosed which enable to mitigate such congestion situations. While in ACB reference implementations, congestion mitigation is achieved by prioritizing any UL data originating from a specific terminal 130-1, 130-2 based on the AC into which the respective terminal 130-1, 130-2 is grouped, according to the techniques disclosed hereinafter, prioritizing and load balancing is possible based on properties of the UL data itself.

E.g., the terminals 130-1, 130-2 may be selected from the group comprising: a smartphone; a cellular phone; a table; a notebook; a computer; a smart TV; a MTC device, an IoT device; etc.

An MTC or IoT device is typically a device with a low to moderate requirement on data traffic volumes and relaxed delay requirements. Additionally, communication employing MTC or IoT devices should achieve low complexity and low costs. Further, energy consumption of an MTC or an IoT device should be comparably low in order to allow battery-powered devices to function for a comparably long duration: The battery life should be sufficiently long.

The eNB 112 is connected with a gateway node implemented by a serving Gateway (SGW) 117. The SGW 117 may route and forward payload data and may act as a mobility anchor during handovers of the terminal 130.

The SGW 117 is connected with a gateway node implemented by a packet data network Gateway (PGW) 118. The PGW 118 serves as a point of exit and point of entry of the cellular network 110 for data towards a packet data network (PDN; not shown in FIG. 1): for this purpose, the PGW 118 is connected with an access point node 121 of the packet data network. The access point node 121 is uniquely identified by an access point name (APN). The APN is used by the terminal 130 to seek access to the packet data network. The PGW 118 can be an endpoint of the data connection 160.

The eNB 112, the SGW 117, the PGW 118, and the access point node 121 form the user plane or data plane of the cellular network 110. Control functionality of the user-plane nodes is performed by the control plane of the cellular network 100.

Access functionalities of the terminals 130-1, 130-2 to cellular network 110 may be controlled by a control node implemented by a mobility management entity (MME) 116. The MME 116 checks authorization of a subscriber of the network 110 that is associated with the terminal 130 to access the cellular network 110 via the radio link between the terminal 130 and the eNB 112. The MME 116 is connected via a reference point operating according to the S1-MME protocol with the eNB 112. Further, the MME 116 is connected via a reference point operating according to the S11 protocol with the SGW 117.

In order to check authorization of the subscriber of the network 110 to access the network 110, the MME 116 is connected with a Home Subscriber Server (HSS) 115 via a S6a reference point. Subscriber-specific data such as subscription plans etc. may be stored in a repository of the HSS 115.

Policy and charging functionality is controlled by a control node 119 implemented for example by a Policy and Charging Rules Function (PCRF) 119. The PCRF 119 is connected via a reference point operating according to the Gx protocol with the PGW 118. Policies can be enforced by the PGW 118. The PGW 118 can report charging-related information to the PCRF 119.

FIG. 2 illustrates aspects of a communication protocol stack 190 which network elements of the cellular network 100 employ to communicate data and control messages. FIG. 2 shows that lowest in hierarchy is the so-called physical (PHY) layer 191, sometimes also referred to as layer 1. The PHY layer 191 handles tasks such as coding, digital and analog signal processing, and modulation. The PHY layer 191 accesses the air interface. Details of the PHY layer 191 according to the 3GPP LTE technology are specified in 3GPP TS 36.211, 36.212, and 36.213.

In hierarchy above the PHY layer 191 is the Medium Access Control (MAC) layer 192. The MAC layer 192 implements control of the PHY layer 191 such as scheduling communication of data on the radio link 101. The MAC layer 192 is specified by 3GPP TS 36.321.

Next, the Radio Link Control (RLC) layer 193 maintains the data connection 160, e.g., by controlling properties of an Automatic Repeat Request (ARQ) protocol. The RLC layer 193 is specified by 3GPP TS 36.322.

The Packet Data Convergence Protocol (PDCP) layer 194 is responsible for transport functions such as header compression and security. The PDCP layer 194 is specified by 3GPP TS 36.323. Sometimes, the combination of MAC layer 192, RLC layer 193, and PDCP layer 194 is referred to as layer 2.

Above layer 2 192, 193, 194 is the RRC layer 195. The RRC layer 195 handles broadcast of system information, paging, establishment of RRC connections, and establishment, configuration, maintenance and release of data connections 160. RRC layer 195 is sometimes referred to as layer 3. Layer 1, 2, and 3 may be defined in the Open Systems Interconnection (OSI) model.

The UL data may originate from one or more layers, e.g., Ethernet or application layers, above the RRC layer 195 (not shown in FIG. 2).

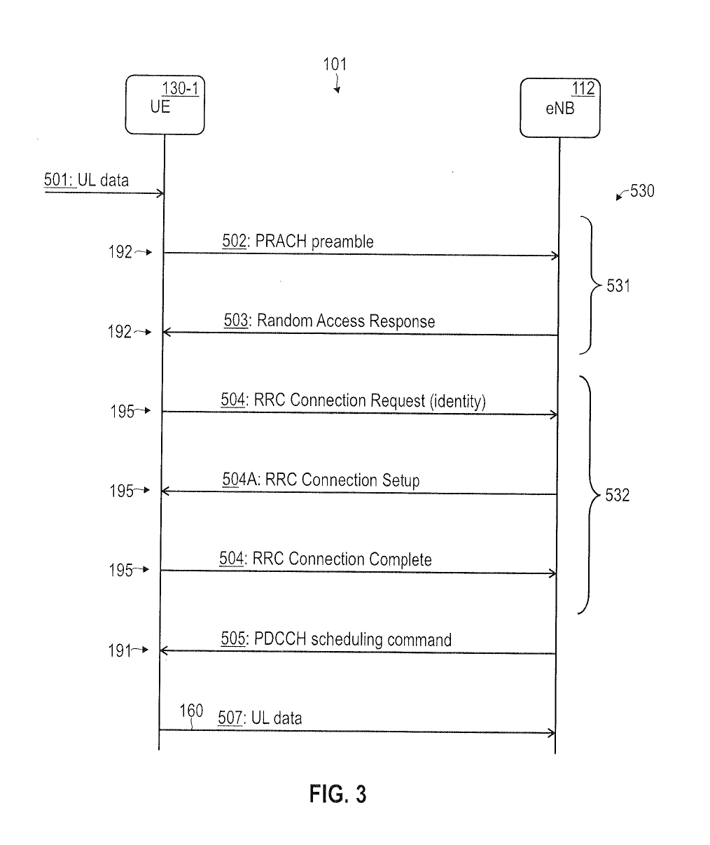

FIG. 3 illustrates aspects of a setup procedure 530 for establishing the data connection 160 on the radio link 101. In particular, FIG. 3 is a signaling diagram where for each message 502-505 communicated on the radio link 101 it is respectively indicated between which layers 191-194 of the communication protocol stack 190 signaling takes place. In FIG. 3, a scenario is illustrated where initially the terminal 130-1 (labeled UE in FIG. 3) is not attached to the cellular network 100. E.g., the terminal 130-1 may be operated in the RRC idle state.

Then, UL data 501 arrives, e.g., in a transmit buffer of the terminal 130-1. Thus, a need for communication of the UL data 501 on the radio link 101 arises. The terminal 130-1, in response to the need for communication of the UL data 501, initiates the setup procedure 530. This is done by communicating a control message 502 in shared resources on the Physical Random Access Channel (PRACH); the terminal 130-1 sends the control message 502 and the eNB 112 receives the control message 502.

The PRACH implements a random access UL channel. The PRACH can be used by terminals 130-1, 130-2 which do not have an established data connection 160 available for communicating in dedicated resources access node with the eNB 112. Due to the shared resources, collisions/contention can occur which are mitigated by using orthogonal preamble sequences.

The control message 502 may be indicative of an identity of the terminal 130-1. E.g., the identity may be identified by the Random Access Radio Network Temporary Identifier (RA-RNTI). The identity—due to the random-access nature of the procedure may not yet be unique.

The control message 502 comprises a preamble sequence or coding preamble which is selected at least partly in a random procedure (not illustrated in FIG. 3) and which facilitates distinguishing plural terminals 130-1, 130-2 communicating in the same shared resources on the PRACH. In response to receiving the control message 502, the eNB 112 responds with the Random Access Response control message 503. The Random Access Response control message 503 includes a temporary identity assigned by the eNB 112 to the terminal 130-1, the so-called Temporary C-RNTI. During contention-based random access procedure, the terminal 130-1 stores received Temporary C-RNTI. The Random Access Response control message 503 may be accompanied by a UL grant. Contention between plural terminals 130-1, 130-2 is still possible.

The control messages 502, 503 are part of a random access part 531 of the setup procedure 530. The control messages 502, 503 are associated with the MAC layer 192. The random access part 531 of the setup procedure 530 is followed by a RRC part 532 of the setup procedure 530.

In the example of FIG. 3, the RRC part 532 comprises a RRC Connection Request control message 504. The RRC Connection Request control message 504 is communicated on the radio link 101 from the terminal 130-1 to the eNB 112; i.e., the UEs 130-1 sends the RRC Connection Request control message 504 and the eNB 112 receives the RRC Connection Request control message 504. The RRC Connection Request control message is associated with the RRC layer 195. The RRC Connection Request control message 504 is communicated in dedicated resources of an UL control channel, e.g., the UL Shared Channel (UL-SCH). These dedicated resources may be indicated by UL resources accompanying the Random Access Response control message 503. The dedicated resources are reserved for use by the one or more terminals identified by a given RA-RNTI and/or C-RNTI; due to contention, this may be more than the terminal 130-1.

The RRC Connection Request control message 504 may comprise a unique indicator indicative of the identity of the terminal 130-1, e.g., the System Architecture Evolution (SAE) Temporary Mobile Subscriber Identity (S-TMSI) and/or the International Mobile Subscriber Identity (IMSI), e.g., depending on whether the terminal 130-1 had been attached to the cellular network 100 previously. The RRC Connection Request control message 504 may include the Temporary C-RNTI and thus be linked to the Random Access Response control message 503. Based on the unique indicator indicative of the identity of the terminal 130-1 being echoed back by the eNB 112 (not shown in FIG. 3), potential contention between plural terminals 130-1, 130-2 may be resolved.

Further, the RRC Connection Setup control message 504A establishes the data connection 160 which is confirmed by the RRC Connection Complete control message 504B. The data connection 160 may comprise a signaling radio bearer (SRB) and a data radio bearer (DRB).

A scheduling command is sent on the Physical Downlink Control Channel (PDCCH); this scheduling command may be used in order to communicate the UL data 501 in a corresponding payload message 507 on the Physical UL Shared Channel (PUSCH). At this point, the data connection 160 is established. The techniques of signaling the resources for communicated the UL data are not germane 501 for the techniques disclosed herein; other techniques of signaling the resources may apply.

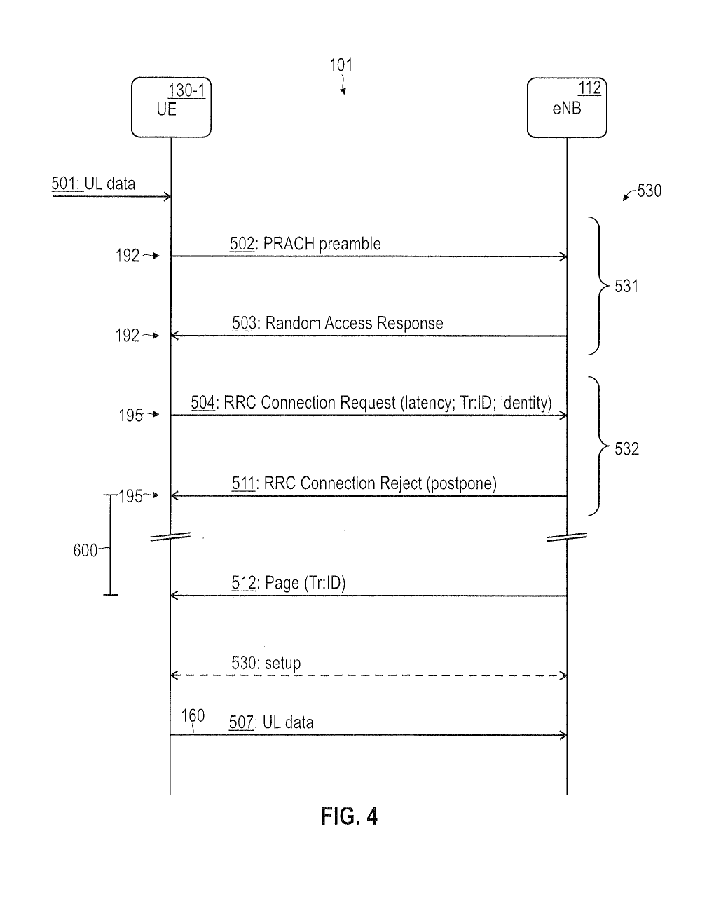

FIG. 4 illustrates aspects of the setup procedure 530 for establishing the data connection 160 on the radio link 101. In particular, FIG. 4 illustrates a scenario where, initially, the data connection 160 is rejected. I.e., in detail the request for establishing the data connection 160 is rejected. The data connection 160 is rejected, because the communication of the UL data 501 is postponed 600. In detail, depending on the delay requirement 161, the eNB 112 decides to postpone the communication of the UL data 501. With respect to FIG. 4, details of the signaling flow implementing such postponing 600 of the communication of the UL data 501 are illustrated.

In the example of FIG. 4, 501-503 correspond to 501-503 of FIG. 3. Further, in the example of FIG. 4, the RRC Connection Request control message 504 includes additional information if compared to the example of FIG. 3. In particular, the RRC Connection Request control message 504 in the example of FIG. 4 is indicative of the delay requirement 161 of the UL data 501. Based on this information on the delay requirement, the eNB 112 can take the decision to postpone the communication of the

UL data 501. This triggers the rejection of the data connection 160 by means of a RRC Connection Reject control message 511 communicated from the eNB 112 to the terminal 130-1, i.e., sent by the eNB 112 and received by the UEs 130-1.

In the example of FIG. 4, the RRC Connection Request control message 504 further includes a transaction ID; the transaction ID is optional. The transaction ID is indicative of the UL data 501. I.e., the transaction ID corresponds to an indicator indicative of the UL data 501. In some examples, the transaction ID may be uniquely assigned to the

UL data 501. The transaction ID facilitates bookkeeping of outstanding needs for communication. E.g., where a plurality of UL data is required to be communicated on the radio link 101, by means of the respective transaction IDs it is possible to discriminate between each one of the plurality of UL data. Alternatively or additionally to the transaction ID, it is also possible that the RRC Connection Request control message 504 includes further information, e.g., a size of the UL data 501, etc. (not shown in FIG. 4).

In response to communicating the RRC Connection Request control message, the RRC Connection Reject control message 511 is communicated from the eNB 112 to the terminal 130-1, i.e., sent by the eNB 112 and received by the terminal 130-1. The RRC Connection Reject control message 511 rejects the data connection 160. Because the data connection 160 is rejected, it is not possible to communicate the UL data 501 from the terminal 130-1 to the eNB 112.

In order to later pick up on communicating of the UL data 501, the eNB 112 and/or the MME 116 and/or another node of the network 100, e.g., of a core of the network 100, stores the transaction ID indicative of the UL data 501 in a memory and further stores the indicator indicative of the identity of the terminal 130-1 in the memory, e.g., the RA-RNTI and/or and/or the C-RNTI and/or the the S-TMSI and/or IMSI.

Because the memory is accessible by the eNB 112 within the core of the network 100, the memory is associated with the eNB 112. Then, at a later point in time after said postponing 600, it is possible to access this information in order to execute a further setup procedure 530 for establishing the data connection 160 and, eventually, communicating the initially postponed 600 UL data 501.

Likewise, the terminal 130-1 may store the UL data 501 in an UL buffer and optionally may further stores the transaction ID indicative of the UL data 501. Optionally, the terminal 130-1 may further store the indication indicative of the identity of the terminal 130-1, e.g., the RA-RNTI and/or and/or the C-RNTI and/or the the S-TMSI and/or IMSI.

In some examples, the terminal 130-1 does not need to be aware of the reason for the rejection of the data connection 160. In such examples, it is not required that the RRC Connection Reject control message 511 includes an indicator indicative of the postponing 600. Such implementations may reduce the signaling overhead on the radio link 101 and/or may simplify the complexity of logic required at the terminal 130-1.

In the example of FIG. 4, that RRC Connection Reject control message 511 includes an indicator indicative of postponing 600 at the communication of the UL data 501. As such, the respective indicator indicates the reason for rejection of the data connection 160 to the terminal 130-1. The indicator indicative of postponing 600 informs the terminal 130-1 that—even though the data connection 160 is rejected for the time being—communication of the UL data 501 is not rejected altogether, but merely postponed.

The indicator indicative of the postponing 600 may take various forms in different examples. In some examples, the indicator indicative of postponing 600 may be a Boolean flag. Thus, in some examples, the indicator indicative of said postponing 600 may not specify a certain amount of time for which communication of the UL data 501 is postponed; rather, the indicator indicative of said postponing 600 may indicate that communication of the UL data 501 is postponed until further notice. In other examples, the indicator indicative of said postponing 600 may include an explicit or implicit indication of the amount of time for which the communication of the UL data 501 is postponed (not shown in FIG. 4). Such a scenario may facilitate the terminal 130-1, after expiry of said amount of time, actively re-initiating a further setup procedure for establishing the data connection 160. Here, logic may be provided to some extent at the terminal 130-1 for implementing the postponing 600. This reduces the number of tasks imposed on the eNB 112.

In the example of FIG. 4, the RRC Connection Reject control message 511 is communicated to reject the data connection 160; this is done in order to implement said postponing 600 of communication of the UL data 501. In the scenario of FIG. 4, because the communication of the UL data 501 is postponed, later on, a paging control message 512 is communicated from the eNB 112 to the terminal 130-1, i.e., sent by the eNB 112 and received by the terminal 130-1.

The paging control message 512 prompts the terminal 130-1 to participate in a further setup procedure 530 (in FIG. 4, the further setup procedure 530 is shown in abbreviated form, but may be implemented according to the example of FIG. 3). In this instance of the setup procedure 530, the eNB 112 does not reject the data connection 160; rather, the data connection 160 is established and, eventually, the initially postponed UL data 501 is communicated as part of a respective payload message 507. As can be seen, the paging control message 512 ends the duration of postponing 600 the communication of the UL data 501.

While in the example of FIG. 4 the paging control message 512 is communicated from the eNB 112 to the terminal 130-1, in other examples, a respective paging control message prompting the eNB 112 to participate in the further setup procedure 530 may be communicated from the terminal 130-1 to the eNB 112. In such examples, the paging control message may be implemented by a further PRACH control message 502. In particular, such examples are conceivable where the RRC Connection Reject control message 511 includes an indicator indicative of said postponing 600 and indicates a time duration of said postponing 600; in such examples, the terminal 130-1 can actively pick up on communication of the UL data 501.

As can be seen from FIG. 4, the paging control message 512 includes the indicator indicative of the UL data 501, i.e., includes the transaction ID. Because of this, the terminal 130-1 is informed on the decision of the eNB 112 to trigger a communication of the UL data 501. The UL data 501 may be thus be discriminated from communication of further uplink data in a transmit buffer of the terminal 130-1 (not shown in FIG. 4). Hence, the UL data 501 is selected for the communication on the radio link 101. Scenarios are conceivable where the paging control message 512 does not include the transaction ID. In such a case, the terminal 130-1 may be authorized to send any UL data 501 according to its choice. Here, the terminal 130-1 may prioritize UL data as required, e.g., based on delay times of the UL data in the transmit buffer, the respective delay requirements, and/or the size of the UL data etc. In particular, in such a scenario further UL data—different from the UL data 501—may be selected for communication on the radio link 101. Thus, where the paging control message 512 does not include any transaction IDs that had been previously communicated from the terminal 130-1 to the eNB 112, the paging control message 512 without any previously communicated transaction ID may act as a wildcard allowing the terminal 130-1 to select the UL data to be transmitted at its own choice.

While in the example of FIG. 4 the paging control message 512 includes the transaction ID, in other examples, the transaction ID may be alternatively or additionally included in a further control message of the further setup procedure 530 triggered by the paging control message 512 (not shown in FIG. 4).

Various decision criteria are conceivable for eventually picking up the communication of the UL data 501 after said postponing 600. Such decision criteria may include, but are not limited to: the delay requirement 161 of the UL data 501; a size of the UL data 501; a traffic load of the radio link 101; and the timing policy of communication on the radio link 101. E.g., where the delay of the UL data 501 renders the delay requirement at risk due to a correspondingly long postponing 600, the likelihood of communicating the paging control message 512 in order to trigger the further setup procedure 530 for establishing the data connection 160 may be comparably high. Likewise, where monitoring of the traffic load of the radio link 101 yields that the traffic load has dropped, e.g., below a predefined threshold, the likelihood of communicating the paging control message 512 in order to trigger the further setup procedure 530 for establishing the data connection 160 may be comparably high.

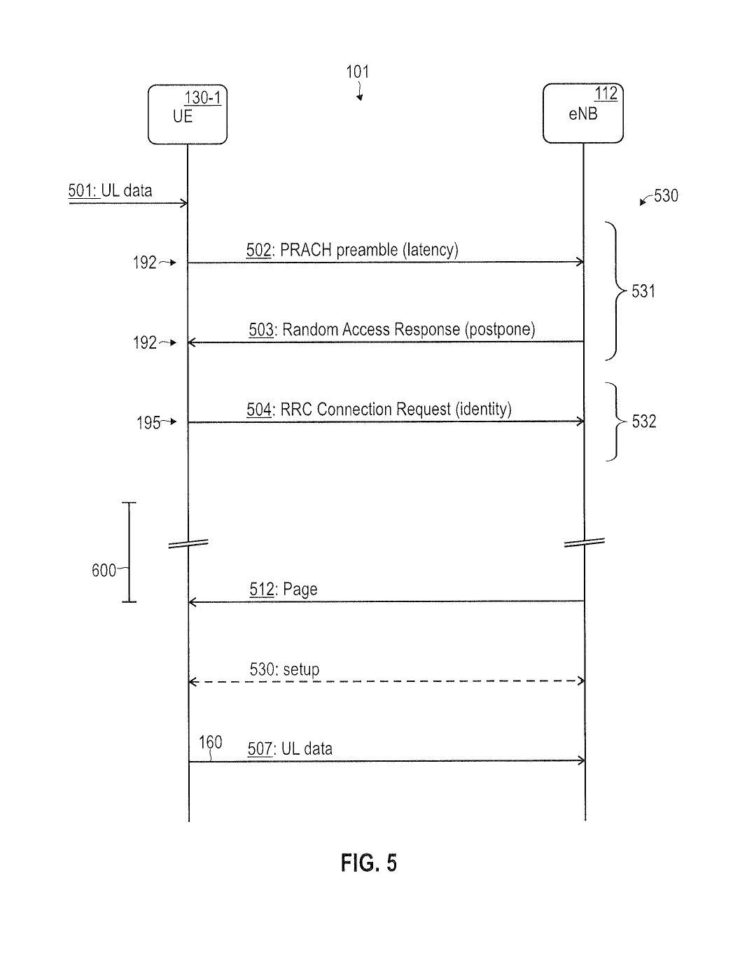

FIG. 5 illustrates aspects of the setup procedure 530 for establishing the data connection 160 on the radio link 101. In particular, FIG. 5 illustrates a scenario where, initially, the data connection 160 is rejected. In particular, FIG. 5 generally corresponds to FIG. 4. However, in the scenario of FIG. 5 it is the PRACH control message 502 that is indicative of the delay requirement of the UL data 501. Then, the Random Access Response control message 503 includes the indicator indicative of postponing 600 to the communication of the UL data 501.

In the example of FIG. 5, the RRC Connection Request control message 504 is still communicated from the terminal 130-1 to the eNB 112, albeit the Random Access Response control message 503 already rejected the data connection 503.

Communication of the RRC Connection Request control message 504 is optional. In the example of FIG. 5, the RRC Connection Request control message 504 is communicated in order to inform the eNB 112 on the identity of the terminal 130-1, e.g., using the S-TMSI. As explained above, the eNB 112 may store the respective information on the identity of the terminal 130-1 in a memory in order to facilitate postponing 600. The RRC Connection Request control message 504 may alternatively or additionally include the transaction ID.

In some examples, a control message may be communicated instead of the RRC Connection Request control message 504 which informs the eNB 112 on the identity of the terminal 130-1, e.g., using the S-TMSI and/or IMSI. As explained above, the eNB 112 may store the respective information on the identity of the terminal 130-1 in an associated memory in order to facilitate postponing 600. Such a control message may be a light-weight version of the RRC Connection Request control message 504, e.g., comprising only some of the information included in the full-scale RRC Connection Request control message 504. The control message may alternatively or additionally include the transaction ID.

Because the Random Access Response control message 503 already informed the terminal 130-1 on the postponing 600 of the communication of the UL data 501/on the rejection of the data connection 160, it is not required to send the RRC Connection Reject control message 511 (which would essentially repeat the rejection of the data connection 160).

As can be seen from a comparison of FIGS. 4 and 5, in the scenario of FIG. 4 the first control message indicative of the delay requirement 161 of the UL data 501 is communicated in dedicated resources of the UL-SCH on the radio link 101 and is, furthermore, associated with the RRC layer 195 of the communication protocol stack 190; differently, in the scenario of FIG. 5, the first control message indicative of the delay requirement 161 of the UL data 501 is communicated in shared resources on the PRACH on the radio link 101 and is, furthermore, associated with the MAC layer 192 of the communication protocol stack 190.

Beyond such examples as provided in FIGS. 4 and 5, it is possible that other control messages of the setup procedure 530 are indicative of the delay requirement 161, alternatively or additionally (not shown in the FIGs.).

As will be appreciated from FIG. 5, including the transaction ID, i.e., the indicator indicative of the uplink data 501, in the communication on the radio link 101 is optional.

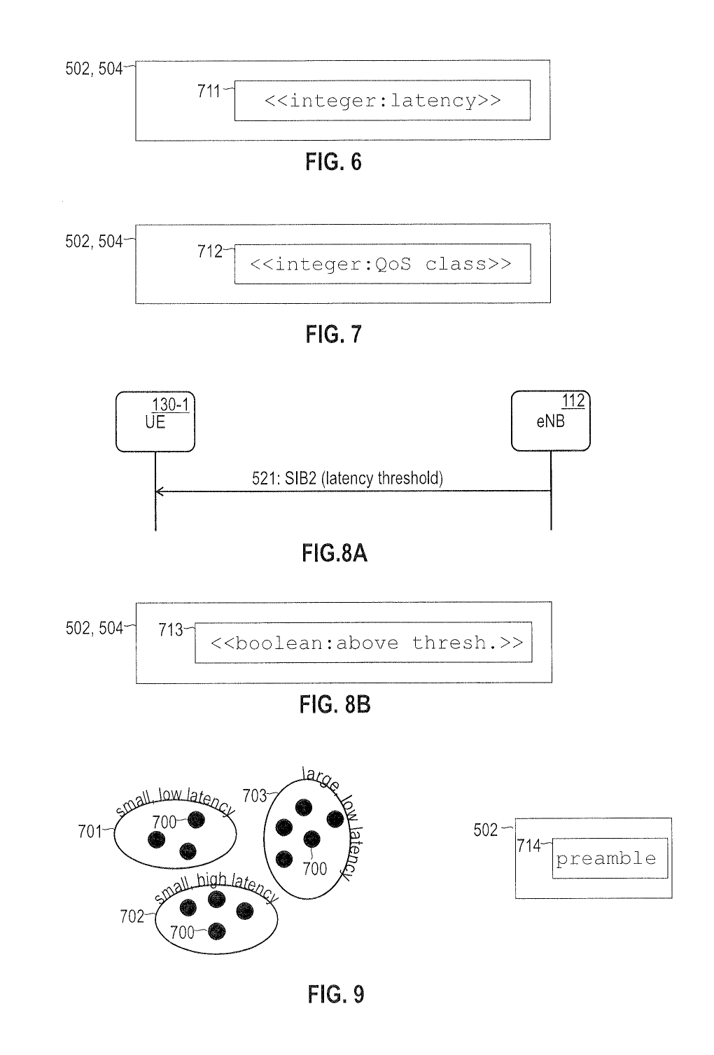

FIG. 6 illustrates aspects with respect to the control message 502, 504 being indicative of the delay requirement 161. Different examples are conceivable for implementing a control message which is indicative of the delay requirement 161. A first example is illustrated in FIG. 6. In the example of FIG. 6, the respective control message 502, 504 includes an indicator explicitly indicative of the delay requirement 161. E.g., the indicator may correspond to a integer number specifying the delay requirement in absolute terms, e.g., in milliseconds or microseconds. Such an implementation enables to indicate the delay requirement at a great accuracy.

FIG. 7 illustrates aspects with respect to the control message 502, 504 being indicative of the delay requirement 161. In the example of FIG. 7, the respective control message 502, 504 includes an indicator implicitly indicative of the delay requirement 161. In the example of FIG. 7, the respective indicator is indicative of a service class of the UL data 501, wherein the service class is associated with the delay requirement 161. E.g., the indicator may correspond to the QCI in some examples, but other service class definitions may be used. Based on the indicator, the eNB 112 may conclude on the delay requirement. Such an implementation is a compromise between signaling overhead on the radio link 101 on the one hand side and, on the other hand side, accuracy in indicating the delay requirement.

FIG. 8A illustrates aspects with respect to a configuration control message 521, in the 3GPP LTE framework a SIB2 control message 521. The SIB2 control message 521 is sent by the eNB 112 on a broadcast channel of the radio link 101; hence, the terminal 130-1 may receive the SIB2 control message even before participating in the setup procedure 530. The SIB2 control message 521 is indicative of a threshold delay. E.g., the SIB2 control message 521 may be indicative of the threshold delay explicitly or implicitly. Based on the indicated threshold delay, the terminal 130-1 can judge whether the delay requirement of the UL data 501 is above or below the threshold delay; corresponding information can be included as 1-bit Boolean indicator in the control message 502, 504, cf. FIG. 8B. Here, the control message 502, 504 is indicative of the delay requirement 161 relative to the threshold delay. Such an implementation reduce the signaling overhead on the radio link 101.

FIG. 9 illustrates aspects with respect to the control message 502 being indicative of the delay requirement 161. In the example of FIG. 9, the control message 502 includes an indicator implicitly indicative of the delay requirement 161. In the example of FIG. 7, the indicator is implemented by the coding preamble 700. As can be seen, different classes 701-703 of coding preambles 700 are defined. E.g., a first class 701 corresponds to small-sized UL data 501, e.g., below a certain threshold, wherein the

UL data 501 has a low delay requirement. Differently, the second class 702 corresponds to small-sized UL data 501 which has a high delay requirement (relaxed delay requirement). Further, the third class 703 third class corresponds to large-sized UL data 501 having a low delay requirement. In various examples, a larger or smaller number of classes 701-703 can be implemented.

By using a coding preamble 700 selected from the corresponding class 701-703, the eNB 112 may be informed on the delay requirement 161 and/or the size of the UL data 501 using the PRACH control message 502. The set of coding preambles 700 and the respective association with the certain classes 701-703 may be announced by the eNB 112 via a respective configuration control message communicated on a broadcast channel of the radio link 101, e.g., via the SIB2 control message 521.

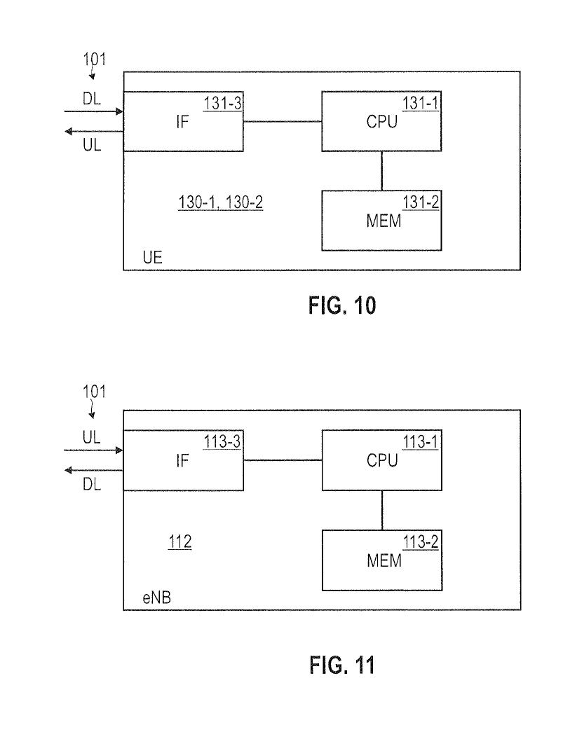

FIG. 10 schematically illustrates the terminals 130-1, 130-2, e.g., an NB-IoT or MTC device. The terminal comprises a processor 131-1, e.g., a single core or multicore processor. Distributing processing may be employed. The processor 131-1 is coupled to a memory 131-2, e.g., a non-volatile memory. The memory 131-2 may store program code that is executable by the processor 131-1. An interface 131-3 may comprise an analog front end and/or digital front end. The interface 131-3 may implement the communication protocol stack 190, e.g., according to the 3GPP E-UTRA RAT and/or according to the 3GPP NB-IoT RAT. Executing the program code may cause the processor 131-1 to perform techniques as disclosed herein, e.g., relating to: participating in the setup procedure 530, 531, 532 for establishing the data connection 160 on the radio link 101; sending and/or receiving (communicating) a control message 502, 504 indicative of the delay requirement 161 of the UL data 501; communicating a control message 503, 511 rejecting the data connection 160; postponing the communication of the UL data 501.

FIG. 11 schematically illustrates the eNB 112. The eNB 112 comprises a processor 113-1, e.g., a single core or multicore processor. Distributing processing may be employed. The processor 113-1 is coupled to a memory 113-2, e.g., a non-volatile memory. The memory 113-2 may store program code that is executable by the processor 113-1. In some examples, the memory 113-2 may be cloud memory in a respective database. The eNB 112 also comprises an interface 113-3 configured to communicate with the terminal 130-1, 130-2 on the radio link 101. The interface 113-3 may comprise an analog front end and/or a digital front end. The interface 113-3 may implement a communication protocol stack 190, e.g., according to the 3GPP E-UTRA RAT and/or according to the 3GPP NB-IoT RAT. Executing the program code may cause the processor 131-1 to perform techniques as disclosed herein, e.g., relating to: participating in the setup procedure 530, 531, 532 for establishing the data connection 160 on the radio link 101; communicating a control message 502, 504 indicative of the delay requirement 161 of the UL data 501; communicating a control message 503, 511 rejecting the data connection 160; postponing the communication of the UL data 501.

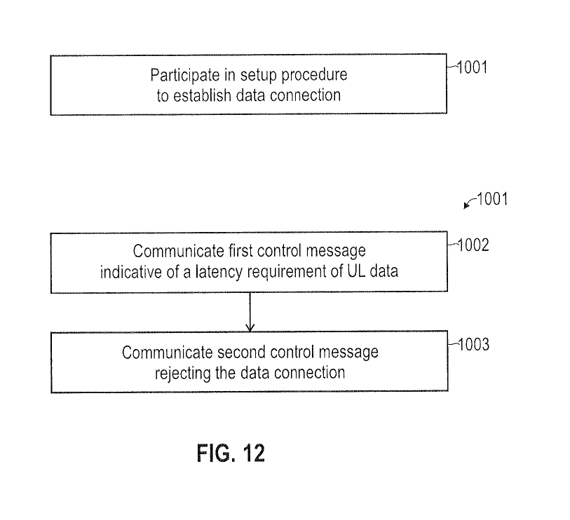

FIG. 12 is a flowchart of a method according to various embodiments. E.g., the method of FIG. 12 may be executed by the at least one processor 131-1 of the terminal 130-1, 130-2 upon executing the program code stored in the memory 131-2. Alternatively or additionally, the method according to FIG. 12 may be executed by the at least one processor 113-1 of the eNB 112 upon executing the program code stored in the memory 113-2.

First, at 1001, participation in the setup procedure 530, 531, 532 for establishing the data connection 160 on the radio link 101 takes place. Participation in the setup procedure 530, 531, 532 may include communication (sending and/or receiving) of at least one control message and/or execution of logic.

In particular, participation in the setup procedure 530, 531, 532 may include 1002 and 1003. At 1002, a first control message is communicated, the first control message being indicative of the delay requirement 161 of the UL data 501. E.g., the first control message may be implemented by the PRACH control message 502 and/or the RRC Connection Request control message 504.

Next, at 1003, a second control message is communicated, the second control message rejecting the data connection 160. E.g., the second control message may be implemented by the Random Access Response control message 503 and/or the RRC Connection Reject control message 511. The second control message, at 1003, is communicated in response to communicating the first control message at 1002. In some examples, communicating the second control message 1003 may be selectively executed depending on the delay requirement 161 as indicated by the first control message.

In some examples, the first control message communicated at 1002 and/or the second control message communicated at 1003 may include further information. E.g., in some examples, the first control message may include an indicator indicative of the UL data 501, e.g., may include the transaction ID. E.g., in some examples, the first control message may include an indicator indicative of the size of the UL data. E.g., in some examples, the second control message communicated at 1003 may include an indicator indicative of postponing 600 the communication of the UL data 501, either until further notice, or for a certain amount of time. E.g., in some examples, the indicator indicative of postponing 600 may indicate the amount of time so that the terminal 130-1 may later on actively pick up on the communication of the UL data 501 after said postponing 600. Such further information as disclosed above is optional. Examples are conceivable where no further information is included.

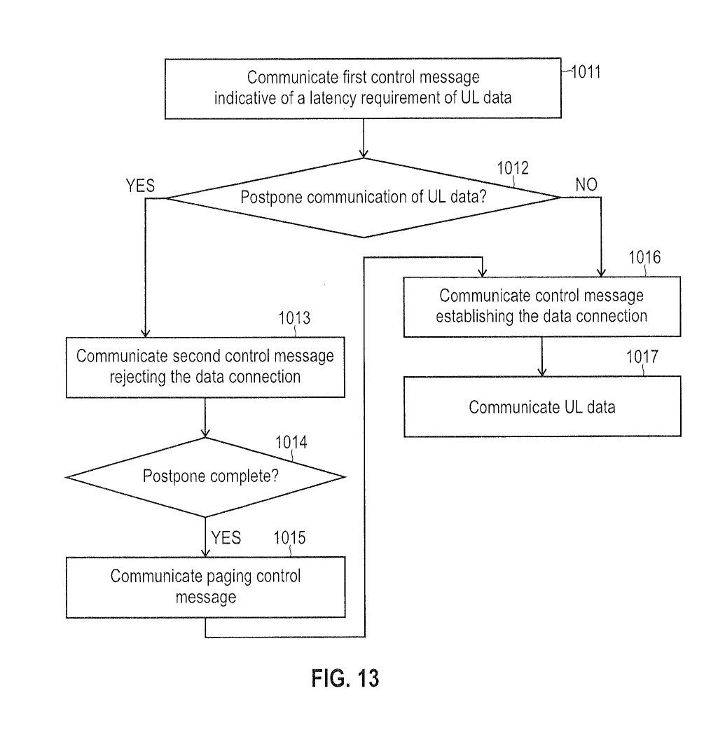

FIG. 13 is a flowchart of a method according to various embodiments, wherein the method illustrates details of selectively executing communicating the second control message 1003 depending on the delay requirement 161. E.g., the method of FIG. 13 may be executed by the at least one processor 131-1 of the terminal 130-1, 130-2 upon executing the program code stored in the memory 131-2. Alternatively or additionally, the method according to FIG. 13 may be executed by the at least one processor 113-1 of the eNB 112 upon executing the program code stored in the memory 113-2.

1011 corresponds to 1002. At 1012, it is checked whether the communication of the UL data 501 should be postponed. E.g., the logic for checking at 1012 may be implemented at the eNB 112 and/or the terminal 130-1.

If, at 1012, it is decided that the communication of the UL data 501 is postponed, at 1013, the second control message rejecting the data connection 160 is communicated. As such, 1013 corresponds to 1003.

Then, it is checked at 1014, whether postponing 600 of communication of the UL data 501 is completed. E.g., logic for checking at 1014 may be implemented at the eNB 112 and/or the terminal 130-1.

If, at 1014, it is decided that postponing 600 of communication of the UL data 501 has finished, the paging control message is communicated at 1015. The paging control message prompts a further setup procedure 530, 531, 532 for establishing the data connection 160.

A corresponding control message establishing the data connection is communicated at 1016; e.g., the control message establishing the data connection may correspond to the PDCCH scheduling command 505.

The control message establishing the data connection at 1016 is also communicated if, at 1012, it is decided that communication of the UL data 501 should not be postponed. In response to communicating the control message establishing the data connection at 1016, next, at 1017, the UL data 501 is communicated.

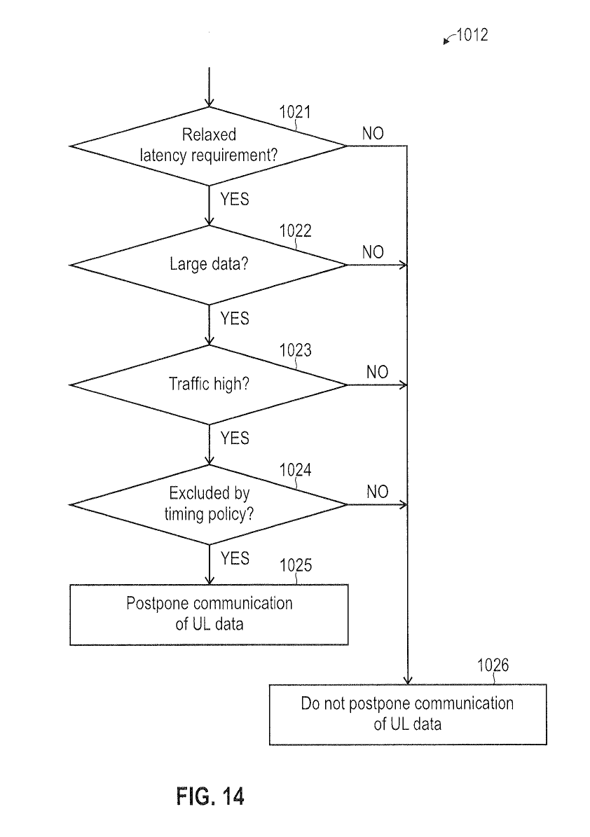

FIG. 14 is a flowchart of a method according to various embodiments, wherein the method illustrates details of the decision logic for deciding whether to postponed communication of the UL data 501. As such, the method as illustrated in FIG. 14 may be executed as part as 1012. E.g., the method of FIG. 14 may be executed by the at least one processor 131-1 of the terminal 130-1, 130-2 upon executing the program code stored in the memory 131-2. Alternatively or additionally, the method according to FIG. 14 may be executed by the at least one processor 113-1 of the eNB 112 upon executing the program code stored in the memory 113-2.

First, at 1021, it is checked whether a comparably relaxed delay requirement is associated with the UL data 501. At 1021, the delay requirement indicated by the first control message communicated at 1011 may be compared against a delay threshold. In some examples, the delay threshold may be fixedly configured; in still further examples, the delay threshold may be indicated by a respective configuration control message, e.g., the SIB2 control message 521. If, at 1021, it is judged that the delay requirement of the UL data 501 is strict—e.g., is below the threshold delay—, it is decided to not postpone the communication of the UL data 501, 1026.

However, if at 1021 it is judged that the delay requirement is comparably relaxed, next, at 1022, it is checked whether the UL data is of large size. E.g., at 1022, the size of the UL data 501 may be compared with a size threshold. E.g., the size threshold may be fixedly configured; In further examples, the size threshold may be indicated by a respective configuration control message, e.g., the SIB2 control message 521. If, at 1022, it is judged that the size of the UL data 501 is comparably small, it is decided to not postpone the communication of the UL data 501, 1026.

However, if, at 1022, it is judged that the size of the UL data 501 is comparably large, next, at 1023, it is checked whether the traffic load on the radio link 101 is comparably high, e.g., above a certain traffic threshold. If, at 1023, it is judged that the traffic load on the radio link 101 is comparably small, it is decided to not postpone the communication of the UL data 501, 1026.

However, if, at 1023, it is judged that the traffic load on the radio link 101 is comparably high, next, at 1024, it is checked whether communication of the UL data 501 is excluded by a timing policy of communication on the radio link 101.

E.g., the timing policy may specify certain times of a day, days of a month, month of the year, etc. during which restrictions on which particular UL data is to be communicated on the radio link 101 apply. E.g., the timing policy may specify that during certain time periods only UL data having a comparably strict delay requirement is to be communicated on the radio link 101. E.g., the timing policy may specify that during certain time periods only comparably small or large data is to be communicated on the radio link 101. E.g., the timing policy may specify that during certain time periods only certain device classes of terminals 130-1, 130-2 are to communicate UL data on the radio link 101. E.g., as part of 1024 ACB techniques may be implemented.

If, at 1024, it is judged that the timing policy permits communication of the UL data 501, it is decided to not postpone the communication of the UL data 501, 1026.

Otherwise, the communication of the UL data is postponed, 1025.

As will be appreciated from the above, said selectively postponing 600 of the communication of the UL data 501 depends on the delay requirement 161, the size of the UL data 501, the traffic load on the radio link 101, as well as on the timing policy of communication on the radio link 101. It should be understood that the various decision criteria discussed with respect to FIG. 14 may be implemented in a sequence different to the sequence as illustrated in FIG. 14. Further, additional or different decision criteria may be considered when deciding whether to postpone the communication of the UL data 501. Still further, a smaller or larger number of the decision criteria as illustrated in FIG. 14 may be considered when deciding whether to postpone the communication of the UL data 501.

While with respect to FIG. 14 various decision criteria have been disclosed that may be implemented as part of the checking of 1012, respective techniques may be readily applied for checking, at 1014, whether postponing is completed.

Summarizing, techniques have been disclosed which enable to selectively reject a data connection 160 depending on a delay requirement of UL data to be communicated on the radio link. Such techniques may be used to prioritize time-critical UL data over non-time-critical UL data. Load balancing can be implemented. Background data having a relaxed delay requirement can be postponed to implement the communication at a later point in time.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

E.g., while above various examples have been explained with respect to the indicator indicative of the UL data—e.g., the transaction ID—, such an indicator is optional. Various examples may be implemented which do not rely on the indicator indicative of the UL data. E.g., while above various examples have been disclosed with respect to the transaction ID, i.e., the indicator indicative of the uplink data, in other examples, it is not required that the indicator indicative of the UL data is communicated on the radio link.

E.g., while above various examples have been disclosed with respect to the PRACH control message and/or the RRC Connection Request control message, other control messages may be readily used for indicating the delay requirement of the UL data.

E.g., while above various examples have been disclosed with respect to cellular networks, respective techniques may be applied to other kinds of wireless networks such as Institute of Electrical Engineers (IEEE) 802.11X Wi-Fi, Bluetooth, etc.

E.g., while above various examples have been disclosed with respect to UL data, respective techniques may be applied to DL data as well. Furthermore, while above various examples have been disclosed with respect to higher-layer payload data, respective techniques may be employed for communicating control data.

1. A method, comprising:
in response to a need for communication of uplink data on a radio link of a wireless network between a terminal and a node of the wireless network, participating in a setup procedure for establishing a data connection on the radio link;
during the setup procedure, communicating, from the terminal to the node, a first control message indicative of a delay requirement of the uplink data; and
during the setup procedure and in response to said communicating of the first control message, selectively communicating, from the node to the terminal, a second control message rejecting the data connection.

2. The method of claim 1,
wherein the second control message includes an indicator indicative of postponing the communication of the uplink data until further notice and/or for a certain amount of time.

3. The method of claim 1, further comprising:
depending on the delay requirement, selectively postponing the communication of the uplink data,
wherein said communicating of the second control message is executed if the communication of the uplink data is postponed.

4. The method of claim 3,
wherein said selectively postponing of the communication of the uplink data further depends on a size of the uplink data-.

5. The method of claim 3,
wherein said selectively postponing of the communication of the uplink data further depends on a traffic load on the radio link-.

6. The method of claim 3,
wherein said postponing of the communication of the uplink data further depends on a timing policy of communication on the radio link.

7. The method of claim 3, wherein said postponing of the communication of the uplink data comprises:
storing an indication indicative of the uplink data in a memory associated with the node and further storing an indicator indicative of an identity of the terminal in the memory associated with the node; and/or
the terminal storing the uplink data in an uplink buffer.

8. The method of claim 1, wherein the first control message is indicative of the delay requirement relative to a threshold delay, the method further comprising:
communicating, from the node to the terminal and on a broadcast channel of the radio link, a configuration control message indicative of the threshold delay.

9. The method of claim 1,
wherein the first control message is communicated in shared resources on a random access uplink channel of the radio link or is communicated in dedicated resources of an uplink control channel of the radio link.

10. The method of claim 1,
wherein the first control message is associated with a Medium Access Control, MAC, layer of a communication protocol stack or with a Radio Resource Control, RRC, layer of the communication protocol stack-.

11. The method of claim 1,
wherein the first control message includes a coding preamble indicative of the delay requirement.

12. The method of claim 1,
wherein the first control message includes an indicator indicative of a service class of the uplink data, wherein the service class is associated with the delay requirement.

13. The method of claim 1, further comprising:
when said communicating of the second control message is executed, communicating, from the node to the terminal, a paging control message prompting to participate in a further setup procedure for establishing the data connection; and
communicating the uplink data on the radio link employing the data connection established by the further setup procedure.

14. The method of claim 13,
wherein the first control message includes an indicator indicative of the uplink data, and
wherein at least one of the paging control message and a further control message communicated during the further setup procedure selectively includes the indicator indicative of the uplink data-.

15. The method of claim 14, further comprising:
when the at least one of the paging control message and the further control message includes the indicator indicative of the uplink data, selecting the uplink data for the communication on the radio link; and
when the at least one of the paging control message and the further control message does not include the indicator indicative of the uplink data; selecting further uplink data different from the uplink data for the communication on the radio link.

16. The method of claim 3,
wherein said communicating of the paging control message is executed after said postponing of the communication of the uplink data, and
wherein said communicating of the paging control message is executed depending on at least one of the following: the delay requirement of the uplink data; a size of the uplink data; a traffic load of the radio link; and a timing policy of communication on the radio link.

17. A device, comprising:
an interface configured to communicate on a radio link between a terminal and a node of a wireless network; and
at least one processor configured to participate, in response to a need for communication of uplink data, in a setup procedure for establishing a data connection on the radio link,
wherein the at least one processor is further configured to communicate, during the setup procedure and via the interface, a first control message indicative of a delay requirement of the uplink data, and
wherein the at least one processor is further configured to selectively communicate, during the setup procedure and via the interface, a second control message rejecting the data connection.

18. The device of claim 17,
wherein the device comprises the terminal.

19. The device of claim 17,
wherein the device comprises the node.

20. The device claim 17, wherein the device is configured to perform operations comprising:
in response to a need for communication of uplink data on a radio link of a wireless network between a terminal and a node of the wireless network, participating in a setup procedure for establishing a data connection on the radio link;
during the setup procedure, communicating, from the terminal to the node, a first control message indicative of a delay requirement of the uplink data; and
during the setup procedure and in response to said communicating of the first control message, selectively communicating, from the node to the terminal, a second control message rejecting the data connection.
